(19) United States
(12) Patent Application Publication
(10) Pub. No.: US 2017/0124888 A1
(43) Pub. Date: May 4, 2017

(54) Book for illustrating and describing activities

(71) Applicant: Carla Taylor, Alexandria, VA (US)

(72) Inventor: Carla Taylor, Alexandria, VA (US)

(21) Appl. No.: 14/121,293

(22) Filed: Aug. 15, 2014

(51) Int. Cl. G09B 3/00

(52) U.S. Cl. CPC G09B 3/00

(57) ABSTRACT

An interactive personalized activity book for illustrating and describing activities is disclosed. The book is a children's book, the users are a child and the a child's parent or caregiver. The activities are directed to attending preschool or childcare, pre-kindergarten and kindergarten. The book's objective is to help a child successfully transition and become more comfortable with routines and new and/or unfamiliar experience(s); The book contains two kinds of pages: preprinted author's pages and pages for which the child, parent or caregiver, and teacher provide the content, including indicia in the form of text and images related to the routine and new and/or unfamiliar experience. The book includes information to guide parents or caregivers on helping the child ease the transition to a new routine and/or unfamiliar experience. The child, parent or caregiver, and/or teacher can remove pages for which they provide content to create a separate customized book.

### CROSS REFERENCE TO RELATED APPLICATIONS

This is a continuation in part of U.S. Utility application Ser. No. 13/506,930 entitled Book for Illustrating and Describing Activities filed May 25, 2012 whose disclosure is hereby incorporated by reference.

Personalized Activity E-Book, 13903884, May 28, 2013 is also hereby incorporated by reference.

### FIELD OF THE INVENTION

The present invention is directed to a set of three books or illustrating and describing activities to a user of the book, more particularly, the present invention is directed to such a book for activities such as, but not limited to school-day routines.

### BACKGROUND OF THE INVENTION

People, especially children, about to encounter new situations and experiencing new situations may find the anticipation and experience very stressful. This can be particularly overwhelming for children entering what is to them a “thing called school.” If they know anything at all about school, they know that they are about to be dropped off in a classroom and that their parent or caregiver will leave and they are left to wait for unknown experiences and for an unexpected period. This is similar to an adult showing up for a new job without seeing a job description. Children, like adults, need to know what to expect in order to reduce anxiety so that they feel comfortable enough to adapt to the new situation. If the new situation is school, a child needs to feel comfortable enough to succeed. In addition, there are many such situations for a young child such as: attending a new play group (i.e., a gathering of children for the purpose of playing together); attending summer camp for the first time; welcoming a new sibling into the family; welcoming and caring for a new pet; moving (e.g., to a new home and school); visiting the doctor, dentist, zoo, library, school-trip, playground, birthday- or other party with his peers, and participation on a sports team.

In addition, there are many situations for which the interactive activity book can help children successfully transition to the new situation by performing the following functions: alleviating anxiety regarding a new situation by letting the child know what to expect from the new situation; helping the child develop the skills needed to adapt socially and intellectually to the new situation; helping the child build confidence in his/her performance in the new situation; helping the child feel welcomed by others into the new situation; providing the child's parents, caregivers, and teachers, coaches and counselors with information that enables them to support the child's transition to the new situation. This invention is also intended for children of all ages, including teenagers.

Teachers, coaches and/or counselors will heretofore be referred to as“teachers” Teenager's lives tend to be full of changes which create variety of new and unfamiliar circumstances and environments in which a teenage must become familiar in order to succeed. Some of these new circumstances and environments include but are not limited to: Entering high school; Learning time management skills to help with juggling an increasing volume of school-related activities, e.g. completing homework and studying for exams; Establishing a routine after school, e.g., doing homework, eating dinner, getting to bed on time; Coping with different forms of competition—academically, socially and athletically—in a constructive way; Attending proms and other social events with peers; Attending college interviews and learning appropriate conduct for college interviews; And improving social manners (e.g., table manners, making introductions, being a good host).

### SUMMARY OF THE INVENTION

A book for illustrating and describing activities for users of the book. The users of the book are a child and his/her parent or caregiver. The book comprises two types of interior pages: 1) A plurality of pages, heretofore referred to as “author's pages” in which the author of the book provides the content, i.e., text and photographs; and 2) A plurality of activity pages, heretofore referred to as “template pages,” for which a user has the option to customize the content by providing text and photographs.

The “user” refers to one, all, or any combination of the following: child, parent, caregiver or “teacher.”

Each of the “author's pages” are structured the same and contain the following elements:
a) A text label, heretofore referred to as an “activity label,” describing an activity, situation or person, e.g., “Circle Time;” “The Teacher;”
b) A photograph or illustration of the activity, situation or person described by the activity title, e.g., a photograph (“photo”) of children engaged in “Circle Time, or a photo of “The Teacher;”
c) Text , e.g., “Parents' Tips,” to give parents, caregivers, and secondarily “teacher” guidance on how to discuss with the child the activity described and pictured on the page, as well as other information for parents, caregivers and “teachers” to help the child adjust to the activity, situation or person described and pictured on the page.

In an additional aspect of the author's pages, some of the pages include questions or activities intended for the child user to complete with a parent or caregiver to help prepare him/her for a new situation. For example, “What is your teacher's name? Please write or type it here;” “How is the weather today?;” “Sing the alphabet song with your parent or babysitter. Can you fill in the missing letters of the alphabet below?” The purpose of these activities is two-fold: 1) to help the child user develop the skills needed to adapt socially and intellectually to the new situation, e.g., kindergarten; and 2) to provide the child user with the option to personalize the page with their responses to these questions and activities.

In a further aspect of the author's pages, an introduction is provided explaining the value of the activity book in specific relation to young children attending school.

In a further aspect, the authors pages include a description and instruction page on what's contained in the book on how to use the book.

The author's pages can be used alone as an activity book entitled, School is New to Me: A Beginner's Guide to Starting School. Or, it may be used with the “template pages.”

There are two types of template pages: One to be used by the child with his/her parent/caregiver called “student book template” pages; and one to be used by school staff members such as teachers, administrators, counselors or coaches (“teachers”), called “teacher book template” pages.

The child, parent and/or caregiver can interleave the completed pages of the “student book template” into the “author's pages” to create a new book. Similarly, the “teacher” can interleave the completed pages of the “teacher book template” into the “author's pages to create a new book. Additionally, both the “student book template” pages and the “teacher book template” pages can be interleaved into the “author's pages” to create a new book.

The result is a book comprising information, i.e. text, photos and or illustrations, from at least three users: the child, the parent or caregiver, and the “teacher,” resulting in a comprehensive book, the content of which can change to meet the evolving needs of the young child user and his/her parent or caregiver. Additionally, research supports the importance of involving parents, or caregivers and teachers in preparing children to start school and keeping them engaged in school.

Alternatively, the “student book template” pages and “teacher book template” pages can remain separate and distinct from the author's pages.

Referring now to the second set of pages, “template pages,” or a plurality of pages for which the users, child, parent or caregiver, and “teacher” have the option to provide the content, i.e., photos or illustrations and text.

In the current iteration, the “student book template pages” are designed to accomplish two goals: first, to enable the student to customize each page to reflect his/her own school experiences; and second to prepare the student to enter preschool and/or kindergarten ready to learn by completing literacy- and other skills-building exercises. For example, the student is encouraged to personalize the pages and practice school readiness skills by: writing their name, writing their school's name, affixing a photograph of themselves to the page; drawing a picture or illustration; and writing about their school.

Within the “student book template” pages are two sets of pages. The first set of pages contains text and photos and/or illustrations which are provided by the author. Specifically, the pages include the following elements:
A brief text description at the top of the page of the environment or activity depicted in the photograph or illustration on the page, e.g., “Our Artwork;”
A photograph or illustration on the page that depicts the brief text description at the top of thee page, e.g., photos of other children's artwork and a space designated to receive the child user's artwork.
A specific request communicated in text directed to the child user to complete a specified task related to the brief text description and photograph or illustration on the page, e.g., “Draw something and paste it here with your classmates' work.”

The second set of pages within the “student book template” pages contains designated areas to contain text and photos and/or illustrations provided by the child and parent or caregiver users, heretofore referred to as “child user.”

Specifically, these pages include the following elements:
A designated space at the top of the page for the child user to provide a brief text description of an environment, activity, or person, e.g., “my classroom,” “my teacher,” “my family,” “This is my favorite school activity,” “Here are some other things I like to do at school.”
A space designated for the child user to draw or affix a photo of the environment, activity, or person he/she referred to in the brief text description
A designated space for the child user to write about the environment, activity, or person depicted in the photo and described in the brief text description at the top of the page.
In a further aspect of the invention, the “child user” has the option to interleave the pages of the “student book template” into the “author's pages,” to form a new, third book. In addition, the child user has the option to replace the book cover of the “author's pages” with the book cover of the “student book template” to enhance the personalization appearance of the new, third book.
Alternatively, the child user may leave the “student book template” pages and cover page separate from the “author's pages” so that the “student book template” remains separate and distinct from the “author's pages.”

In another aspect of the invention, the “student book template” includes “conversation-starters” suggesting topics the parent can discuss with the child at the end of each school day.

In another aspect of the invention, the “student book template ” includes a personalized “Certificate of Completion” with a space for the child to write his/her name and that states that the child is ready to start school. Dotted lines on the left-hand side of the page indicates that the “Certificate of Completion” is to be cut out and displayed.

Moving now to discuss the second set of template pages: “Teacher book template” pages are to be used by teachers, coaches, and/or counselors, heretofore referred to as “teachers,” to customize the content by providing text and photographs related to, for example, their school, class, or goals for their students.

Within the “teacher book template” pages are two sets of pages. The first set of pages contains the following elements:

Several different customizable book covers for the “teacher” to select and customize with his/her personal information, e.g., his/her name; the name of the school. The teacher can then use the completed customized book cover to replace the book cover on the “author's pages” comprising the book, School is New to Me: A Beginner's Guide to Starting School, so that the content of the book appears to be from the “teacher.”

Additionally, the “teacher” may keep the customized book cover separate from the “author's pages” and keep it as a cover page for the “teacher book template.”

The second set of pages within the “teacher book template” has a structure and physical layout similar to that of the “author's pages.” That is, the “teacher book template” pages contain the same designated areas for text and photos and/or illustrations with the same placement on the page as do the “author's pages.” However, unlike the author's pages which are already populated with text and photos and/or illustrations, the “teacher book template” pages are not populated with text and photos and/or illustrations. Instead the “teacher book template” pages have blank designated areas to receive text and photos or illustrations provided by the “teacher.” Specifically, those designated areas include the following:

a) A designated space to receive a text label, heretofore referred to as an “activity label,” provided by “the teacher,” which describes the activity, environment, or person that will be the subject of the page, e.g., “Our Classroom;” “ The Teacher;”

b) A designated space to receive a photograph or illustration provided by “the teacher” of the activity, environment or person described in the activity label;

c) A designated space to receive text provided by “the teacher,” e.g., “Parents' Tips,” to give parents and caregivers, guidance on how to discuss with the child user the activity, environment or person described and pictured on the page, as well as other information for parents and caregivers to help the child adjust to the activity, environment or person described and pictured on the page.

In an additional aspect of the second set of pages of the “teacher book template,” “the teacher” may interleave pages of the “teacher book template” among the “author's pages” to create a new and distinct book. The fact that the second set of pages is the “teacher book template” has a physical layout and structure similar to that of the “author's pages,” makes the interleaving of the pages appear seamless.

Alternatively, “the teacher” may elect to keep the “teacher book template” separate and distict from the “author's pages.”

Another option is that both the “student book template” pages and the “teacher book template” pages are interleaved into the “author's pages” to create a new and distinct book.

The result is a book comprising information, i.e. text, photos and/or illustrations, from at least four sources: the author, the child, the parent and/or caregiver, and the “teacher.” Research supports the importance of collaboration between families (parents, caregivers and children) and teachers in preparing children to enter school and keeping them engaged in school.

This invention is directed to a personalized interactive activity book arrangement and a method of:

1) Helping a child or teenager (“child”) become more comfortable with and more knowledgeable about routines (including but not limited to daily routines) and new and/or unfamiliar experience(s); and 2)Teaching a child, a context (“the circumstances that form the setting for an event, statement, or idea, and in terms of which it can be fully understood and assessed”) of routines and new and/or unfamiliar experience(s) to promote the successful transition of the child to the new environment, e.g., starting school by:
placing a photograph of the child within the context of the new environment;
introducing the child to activities that prepare the child for the new environment, e.g., writing his/her own name in the activity book; singing the ABCs; playing on a playground; attending a playgroup;
encouraging the child to communicate his/her ideas and impressions about the new and/or unfamiliar experience(s) using a variety of methods: in writing (text), with drawings (visually), and through discussions with parents or caregivers (verbally).
involving the child's parent or caregiver in the transition of the child to new routines and/or unfamiliar experiences;
involving the child's “teacher” in the transition of the child to new routines and/or unfamiliar experiences;

providing a mechanism to create a structure, i.e, an interactive and customizable activity book, to combine information from the following sources: the author, child, parent or caregiver, and “teacher

Further, this invention is directed to a personalized interactive activity book and method of:

Helping a subject become more familiar and therefore more comfortable with routines (including but not limited to daily routines) and new and/or unfamiliar experience(s), e.g.: Attending school or camp; Executing bedtime routines (e.g. taking a bath, putting on pajamas, picking a story book to read, getting into bed, staying in child's own bed); Executing morning routines (e.g., getting dressed, eating breakfast, getting ready for school); Cleaning up one's toys and other possessions; Executing an after-school routine (e.g., eat a snack, do homework, play or relax); Staying with a baby sitter; Spending the night at a friend's house; Joining a sports team; Welcoming a new sibling or pet to the family, etc., and;
This book is expressed in English as well as other languages.

In an aspect of the book arrangement, the book arrangement is an interactive children's activity book, the user is a child and a child's parent or caregiver, and the activities are directed to attending preschool or child care, pre-kindergarten and kindergarten.

### BRIEF DESCRIPTION OF THE DRAWINGS

FIG. 1 is a perspective view of a spiral bound book, heretofore referred to as “author's book” configured in accordance of the principles of the present invention showing the “author's book” partially open.

FIG. 2 is a perspective view of the “author's book” of FIG. 1 showing the front of a single interior book page.

FIG. 3 is a fragmentary view of the “author's book” of FIGS. 1 and 2.

FIG. 4 is an example of the “author's book” being bound by a loose leaf notebook binder so that the user may change the order of the pages in the “author's book” to better represent the child's experiences and/or routines, and/or to interleave pages from the “student book template” and/or interleave pages from the “teacher book template” into the pages of the “authors book” to form a separate and distinct activity book.

FIG. 5 is a sample book cover according the present iteration of the invention.

FIG. 6 is an introduction page for the “author's book.”

FIG. 7 is a page describing why the book if effective;

FIG. 8 is a sample of pages 3 and 4 and represents a multiplicity of the book's interior pages which face one another. FIG. 8 also is an example of a multiplicity of interior pages, heretofore referred to as “author's pages” that contain the following information provided by the author: 1) an activity label describing the activity or environment pictured in the photo or illustration on the page 2) a photo or illustration illustrating the activity label; and 3) text tips to guide parents and caregivers on how to discuss the activity or environment pictured on the page with his/her child(ren); and on certain pages 4) an activity intended for the child to complete with his/her parent or caregiver.

FIG. 9 is an example of the back cover of the “author's book.”

FIG. 10 is an alternative embodiment of the pages of the“author's book” in which each interior page is perforated or dotted along the left side of the page so that each page may be ripped out or cut out by the user and placed in any order the user wishes and/or interleaved among the pages of the “student template pages” or “teacher template pages” to create a distinct personalized activity book that reflects the child's experiences and order of the child's daily activities.

FIG. 11 is a sample cover of the “student book template” which has not yet been populated with text, photos or illustrations by the student, i.e., child.

FIG. 12 is an exploded view of the cover of the “student book template: in which the user's photo is held and retained on the cover page, or any applicable interior activity page, by affixing the photograph to the page with glue or another kind of adhesive.

FIG. 13 depicts the user's photo after it has been affixed to the page by glue or other kind of adhesive.

FIG. 14 is an example of the cover of the “student book template” after it has been populated with text and a photo or illustration by the child, i.e., after the child has written in his/her name and affixed his/her photo.

FIG. 15 is an example of a multiplicity of activity pages, within the “student book template” which have not yet been populated with indicia in the form of text, photos or illustrations by the child.

FIG. 16 is an example of a multiplicity of activity pages, within the “student book template” which has been populated with indicia in the form of text, photos or illustrations provided by the child.

FIG. 17 is an example of another multiplicity of activity pages, within the “student book template” which has not yet been populated with indicia in the form of text, photos or illustrations by the child.

FIG. 18 is example of another multiplicity of activity pages, within the “student book template” which has been populated with indicia in the form of text, photos or illustrations provided by the child.

FIG. 19 is a preferred embodiment of the “student book template” pages in which each “template page” is perforated or dotted along the left side of the page so that each page may be ripped out or cut out by the user and placed in any order the user wishes and/or interleaved among the pages of the “author's pages” and/or “teacher template pages” (defined later) to create a distinct personalized activity book that reflects the child's experiences and order of the child's daily activities.

FIG. 20 is an example of the “student book template” being bound by a loose leaf notebook binder so that the user may change the order of the pages to represent the child's experiences and/or routines, and/or to interleave pages from the “author's book template” and/or interleave pages from the “teacher book template” into pages of the “student book template” to form a separate and distinct activity book.

FIG. 21 is an example of “Let's Talk!” Conversation Starters about School according to the current iteration, designed to give parents and caregivers guidance on how to discuss school experiences with young children (age 2-6 yrs.).

FIG. 22 is an example of a certificate of completion, which the child can personalize by writing his/her name, signifying that the child user is ready to start school upon completion of the “student book template” activities.

FIG. 23 is an example of the front cover of the “teacher book template” designed to identify the “teacher book template” as such and not intended to be populated with indicia in the form of text, photos and/or illustrations by the “teacher”.

FIG. 24 is a sample of the front cover of the “teacher book template” designed to be populated with indicia in the form of text, photos and/or illustrations by the “teacher” in the designated empty spaces. FIG. 21 is a sample of a front cover of the “teacher book template” that has been populated with indicia in the form of text, photos and/or illustrations by the “teacher.”.

FIG. 25 is an example of a multiplicity of activity pages, within the “teacher book template” before it has been populated with indicia in the form of text and images by the teacher.

FIG. 26 is an example of a multiplicity of activity pages, within the “teacher book template” after it has been populated with indicia in the form of text and images by the teacher.

FIG. 27 is a preferred embodiment of the “teacher book template” in which each “template page” is perforated or dotted along the left side of the page so that each page may be ripped out or cut out by the teacher after he/she has populated them with information, and placed in any order the teacher chooses, and/or interleaved among the pages of the “author's pages” and/or “student template pages” to create a distinct activity book that reflects the “teacher's” goals for the child or group of children, e.g., a class or activity group.

FIG. 28 is an example of the “teacher book template” being bound by a loose leaf notebook binder so that the teacher may change the order of the pages, and/or interleave its pages with the “author's book template” and/or the “student book template” to form a separate and distinct activity and/or instructional book.

FIG. 29 is a sample of the interior pages of an activity book comprised of select pages from the “student book template” and select pages from the “teacher book template,” interleaved among select pages of the “author's pages,”, resulting in a distinct activity book which incorporates information from sources, i.e. parents or caregivers and “teachers,” who are critical to the healthy transition of a child to school or another unfamiliar environment.

### DETAILED DESCRIPTION OF DRAWINGS

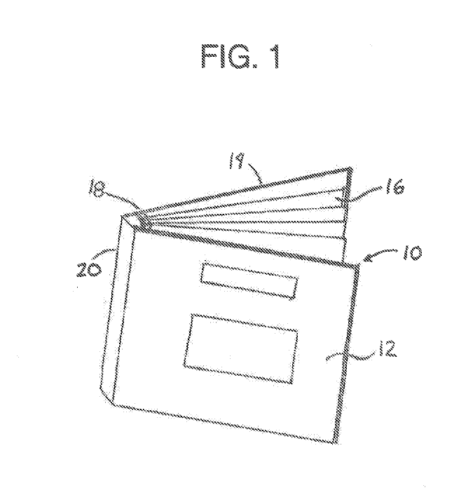

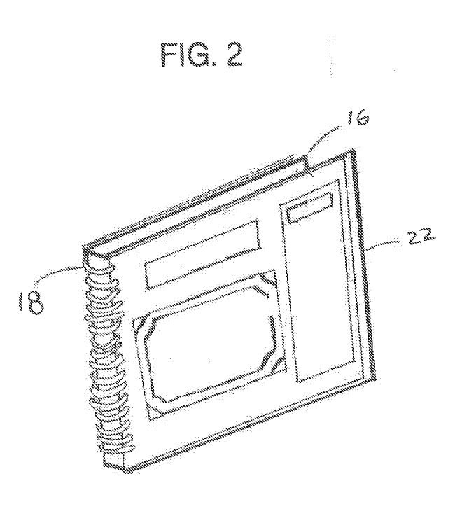

Referring now to FIG. 1 and FIG. 2, there is a typical book 10 currently entitled School is New to Me: A Beginner's Guide to Starting School comprised of “author's pages” configured in accordance with the present invention, wherein the book 10 includes a front cover 12, a back cover 14 and a plurality of pages 16, all secured by a spiral binding, with a spine 20 for displaying the book's title, so that the pages are readily accessible for viewing while being secured between the front and back covers.

A key benefit of a spiral binding 18 of the present invention is illustrated by FIG. 2, showing that any of the book's pages 16 can be bent behind a single page 22 along the spiral binding 18 so as to only display a single page 22 at a time. This is particularly useful when a user wants to show individual pages to the child in an order that is different from the order in which the pages are bound, so that the sequence of activities portrayed better reflect the child's individual routine or schedule. Spiral binding lends itself to the personalization aspect of the activity book.

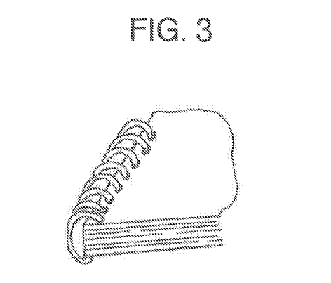

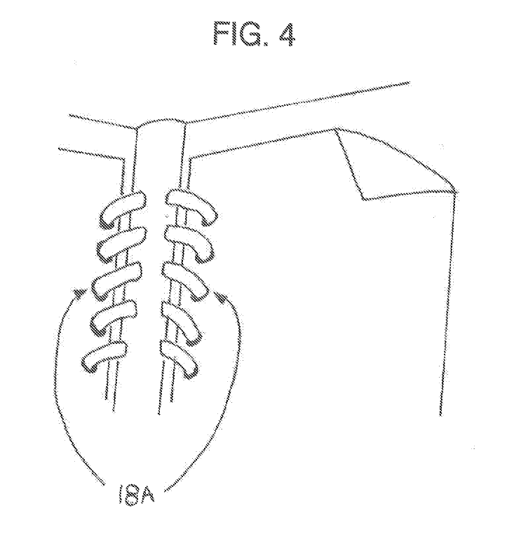

In an alternative embodiment, the binding may be a spiral binding 18 with no spine for printing the book's title, as illustrated by fragmentary view FIG. 3. In yet another alternative embodiment, the binding 18 may be replaced by a loose leaf binding arrangement 18A, as illustrated by fragmentary view FIG. 4, so that the order of pages may be changed. The loose leaf binding arrangement 18A also allows the user to show certain pages and not others in case only certain pages resemble the child's school activities or other experiences. It also allows the user to easily interleave pages of the “author's book” , School is New to Me: A Beginner's Guide to Starting School, with pages from the “student book template” and/or pages from the “teacher book template.”

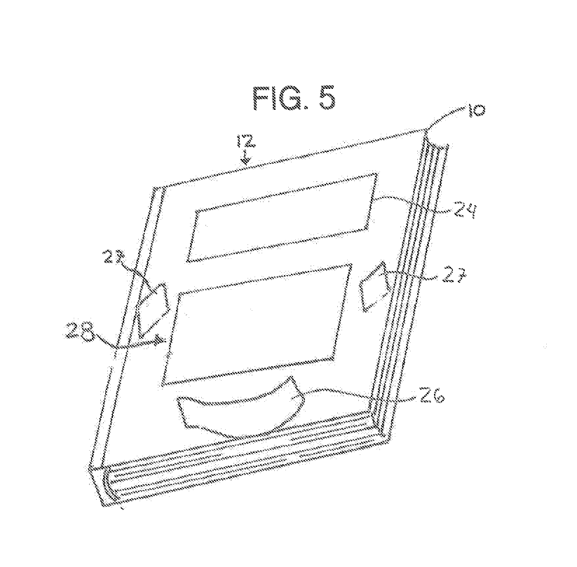

Referring now to FIG. 5, there is shown a front cover 12 of the book 10, where in the cover includes the book's title 24 and text 26 which describes the purpose of the book and describes the book as “an interactive book to help families with the transition to school.”There also are photos 27 and 28 of children engaged in typical school activities for children ages two to six years.

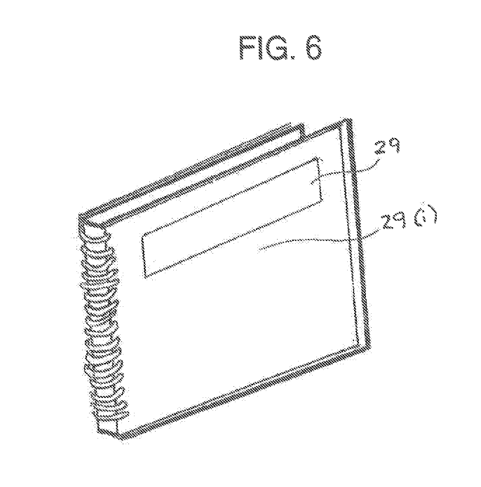

FIG. 6 is a sample first page and an introduction to using the book. In this embodiment of the invention, the introduction 29 is described as “[H]elp for new students and parents. From Carla Taylor, Author & Mother.” The text 29(i) of the introduction 29 also describes a problem, such as but not limited to, the stress of starting school for young children, parents and caregivers.

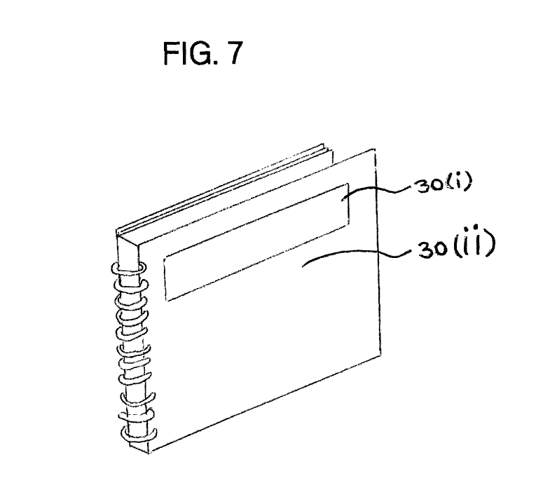

FIG. 7 is a sample second page of the book and provides information on why the book works to help children and families transition to school under the terminology, “Why this book works” 30(i). The text 30(ii) tells the parent or caregiver, for example, how to the book “gives children a game-plan for school;” and helps parents prepare their children for school. In addition, the text 30(ii) explains the use of the “student book template” and how to acquire it.

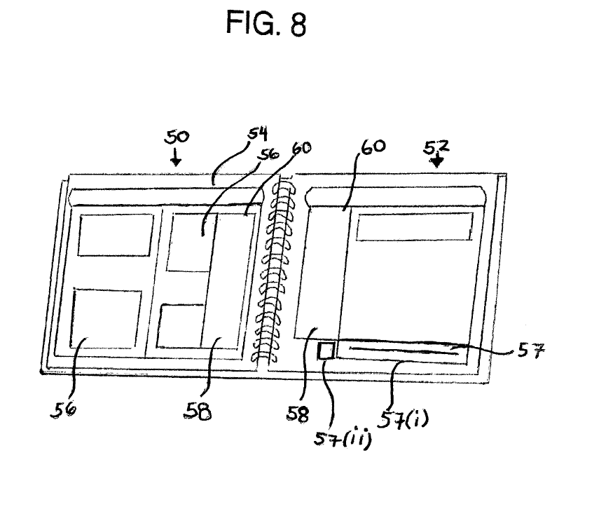

FIG. 8 illustrates the structure of a multiplicity of interior facing pages, e.g., page 3 and page 4, or page 5 and page 6. The facing pages are structured as follows: The page on the left side 50, is an “author's page” providing information about the activity pictured that contains content provided exclusively provided by the author. The page on the right side 52, is an author's page containing an exercise at the bottom of the page intended for the user(s) to fill in a response for.

The “author's page” 50, contains an “Activity label” 54, e.g. “Our School,” describing the activity, person or environment illustrated in the related photographs 56. The photographs 56 depicting the activity described by the text in the Activity Label 54 is e.g., a photo of children in a school setting. The text question or instruction 57 direct the users, i.e. child and/or parent/caregiver, on what information, i.e., text, photo(s), or illustrations(s) to provide in the designated space 57(i). In this iteration of the invention, a child's hand print 57(H) appearing on any page indicates an exercise intended for the child to complete. Text tips 58 for parents provide guidance on how to discuss the activity pictured with their child and recommendations on activities to prepare their child for school. Text tips 58 also include guidance to parents on how to help their children adjust to the school routine. In this embodiment of the invention, the title 60 of these tips is“Parents' Tips.”

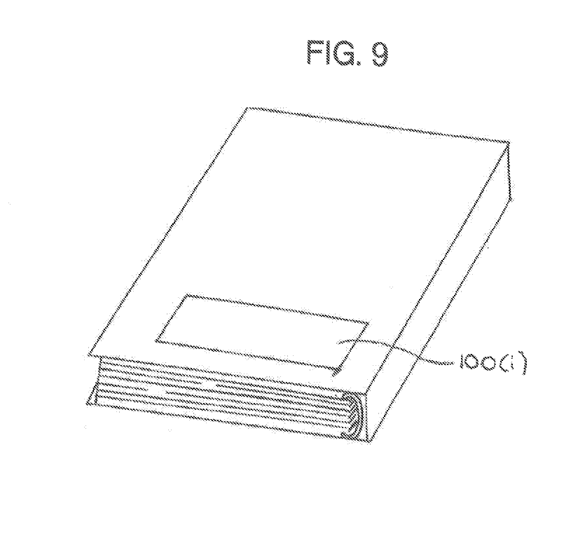

FIG. 9 is the back cover of the book and contains text 100(i) such as book reviews, the author's contact information, social media sites, Web site and additional information the author wants public.

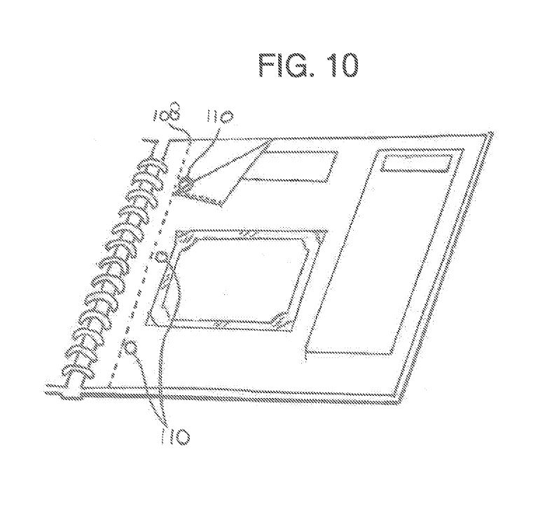

FIG. 10 is a preferred embodiment of the pages of the “author's book” in which each interior page is perforated or dotted 108 along the left side of the page so that each page may be ripped out or cut out by the user and placed in any order the user wishes, and/or interleaved using the holes 110 on the left side of the page, among the pages of the “student template pages” or “teacher template pages” to create a distinct personalized activity book that reflects the child's experiences and order of the child's daily activities.

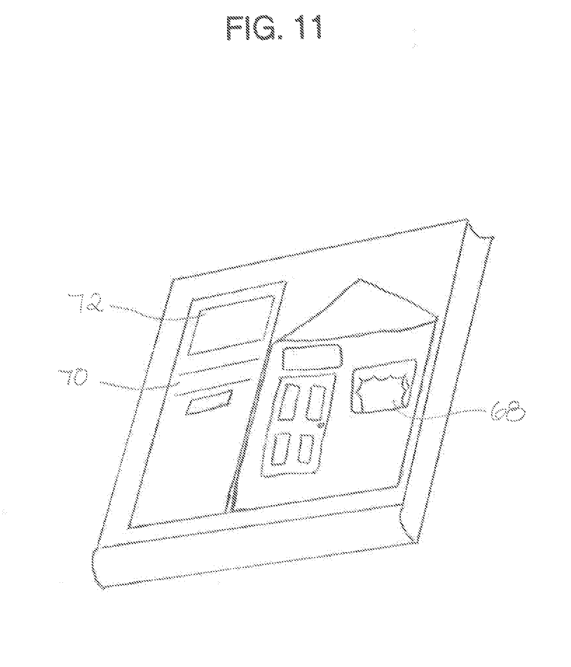

FIG. 11 is the front cover of the “student book template” before the student has populated it with personal information, i.e., his/her name and photograph. In the current iteration, the title 72 is “My School and Me,” the designated space 70 is for the child user to write his/her name and the designated space 68 is the user to affix his/her photo to the cover page.

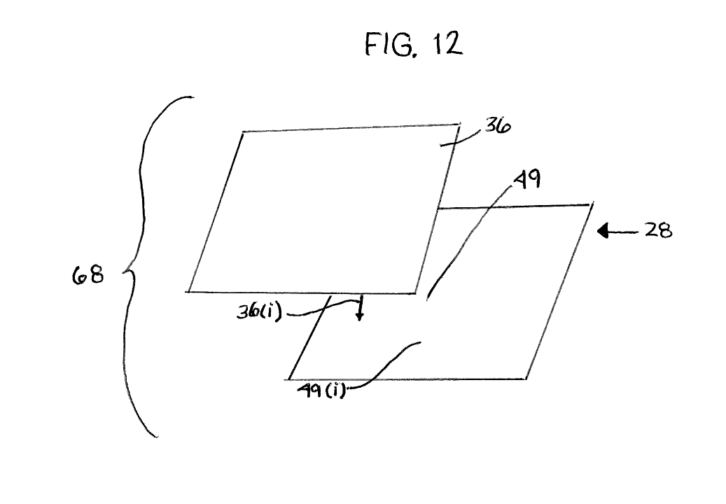

FIG. 12 is a detailed view of the space 68 in FIG. 11 for the child's photo. There are instructions 49(i) to affix the child's photo 36 to the book's cover page, as indicated by directional arrow 36(i), by applying glue 49 or another adhesive. Included in this alternative embodiment is an option in which the adhesive is already applied to the page and ready to hold a photo in place.

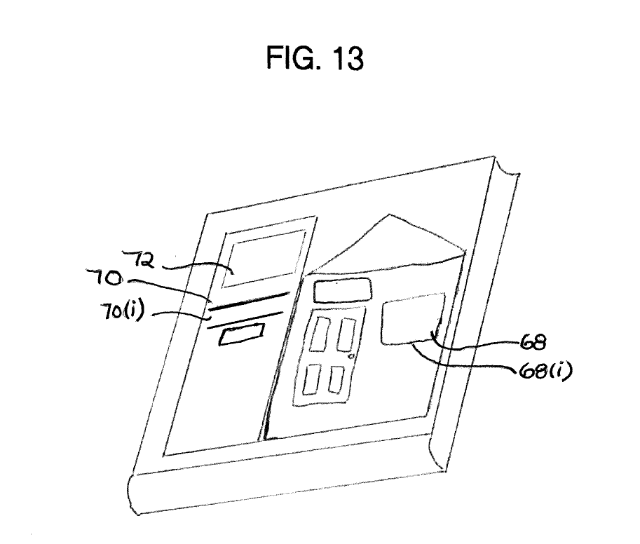

FIG. 13 is the front cover of the “student book template” in FIG. 10 after the student has populated it with indicia in the form of text and an image information, i.e., his/her name and photograph. The current title 72 is “My School and Me;” the child has written his/her name 70(1) “Chris” in the designated space 70; and the child has affixed his/her photo 68(i) in the designated space 68.

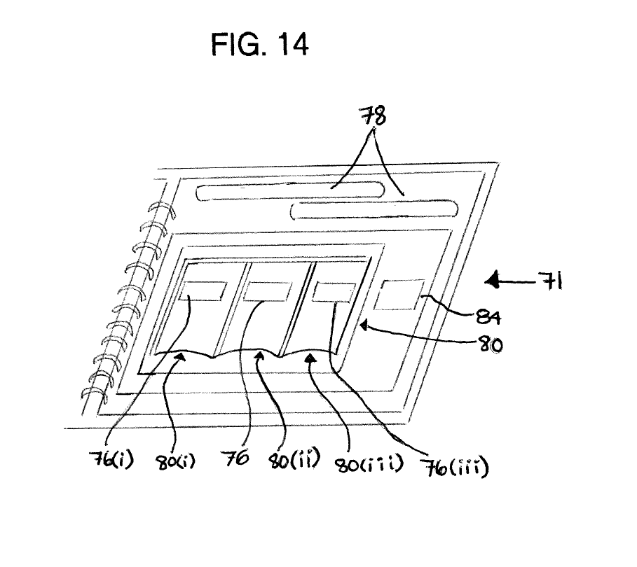

FIG. 14 is an example of a multiplicity of interior activity pages 71 of the “student book template” before the child has provided indicia in the form of text. The space 76 is designated for the child to insert indicia in the form of text. The title 78 identifies the activity and/or setting appearing on the page. In one example, the title 78 says, “Here is my cubby” (“locker”). The photo 80 is of three cubbies. Two of the cubbies, 80(i) and 80(iii) have names 76(i) and 76 (iii) on them and one cubby 80(ii) does not. The text 84 provides instructions for the child and parent or caregiver regarding the activity to be completed, in this case, for the child to write his/her name in the space 76 which represents writing his/her name on his/her cubby. In this instance, the text instructions 84 say, “Please write your name on your cubby.”

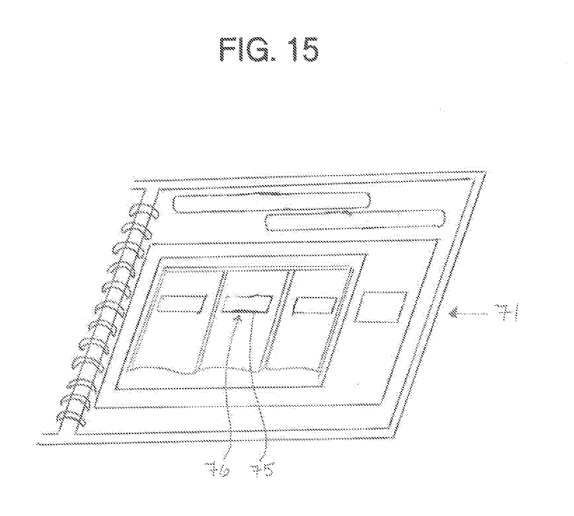

FIG. 15 is an example of a multiplicity of interior activity pages 71 of the “student book template” of FIG. 13 after the child has provided indicia in the form of text in the space 76 by writing his/her name 75.

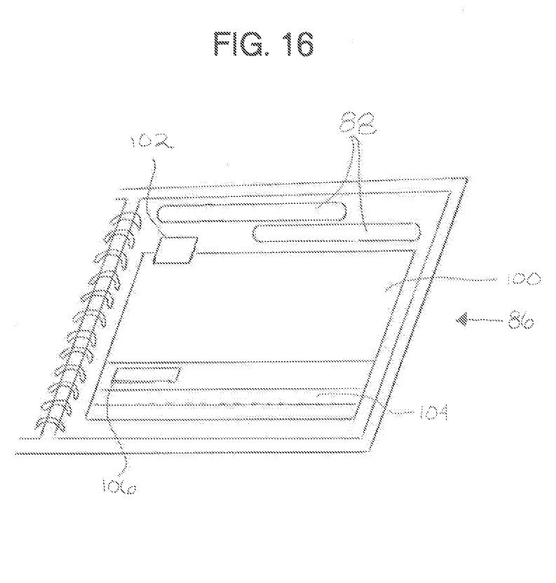

FIG. 16 is an example of another type of multiplicity of interior activity pages 86 within the “student book template” which has not yet been populated with indicia in the form of text, photos and/or illustrations by the child. The activity title 88 identifies an activity, environment and/or setting intended for the child to illustrate by drawing in the space 100 and explain by writing text in the space 104. For example, the activity title 88 says, “Here are other things I like to do at school.” Instructional text 102 directs the child to draw what is indicated by the activity title 88, i.e., what activities the child likes to do at school. The space 104 is designated for the child to write in text about the activity indicated by the activity title 88, i.e., what activities the child likes to do at school. Instructional text 106 directs the child to write in text about the activity indicated by the activity title 88.

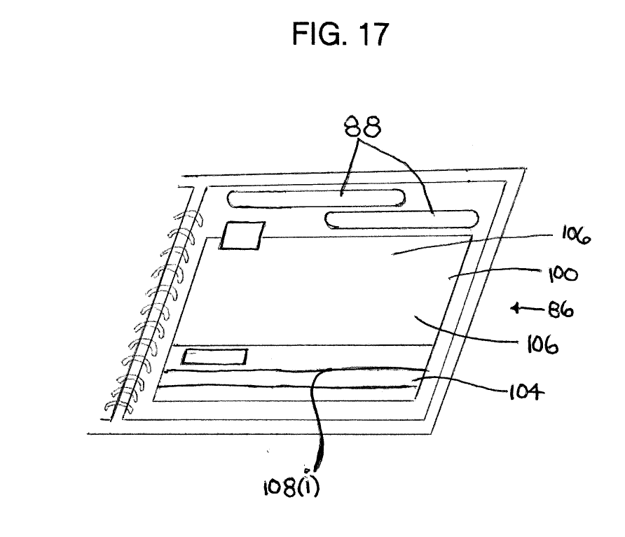

FIG. 17 is an example of the activity page of FIG. 15 after it has been populated with indicia in the form of text, photos and/or illustrations by the child. The activity title 88 identifies an activity, environment and/or setting intended for the child to illustrate by drawing in the space 100 and explain by writing text in the space 104. In this example, the child has populated space 100 with a descriptive illustration 106, and has populated space 104 with descriptive text 108 (i).

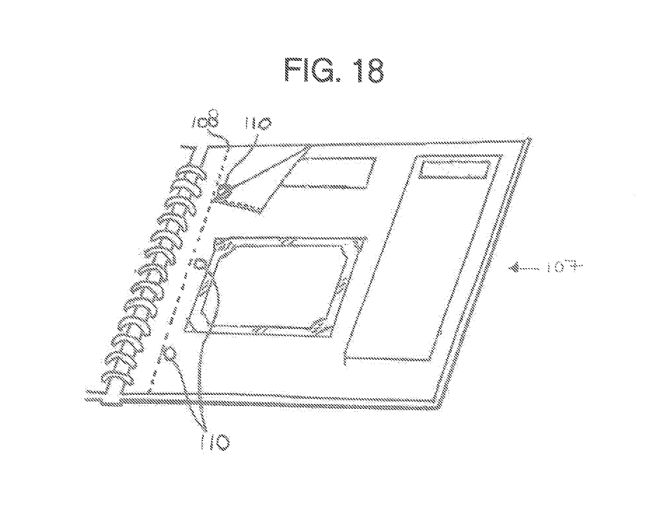

FIG. 18 is a preferred embodiment of a multiplicity of activity pages in the “student book template” in which each activity page 107 is perforated or dotted 108 along the left side of the page so that each page may be ripped out or cut out by the user and placed in any order the user wishes and/or interleaved among the pages of the “author's pages” to create a distinct personalized activity book that reflects the order of the child's daily activities. In another aspect of this alternative embodiment, each activity page 107 of the “student book template” also has holes 110 along the left side of the page to accommodate placement in a ringed binder, so that each page may be removed by the user and placed in any order the user wishes within a ringed binder and/or interleaved within a ringed binder among the pages of the “author's book” and “teacher book template,” both of which will also have holes to accommodate placement in a ringed binder.

In this case the user physically combines the pages from 2 to 3 different books and assembles them into a separate and distinct personalized activity book containing indicia in the form of text and illustrations and/or photos from any combination of the following sources: child, parent, teacher, and author. This structure of the set of three books enables the child and/or parent user(s) to reflect the order of the child's daily activities and/ or the child's experiences and impressions of the new situation, setting or environment, e.g., school.

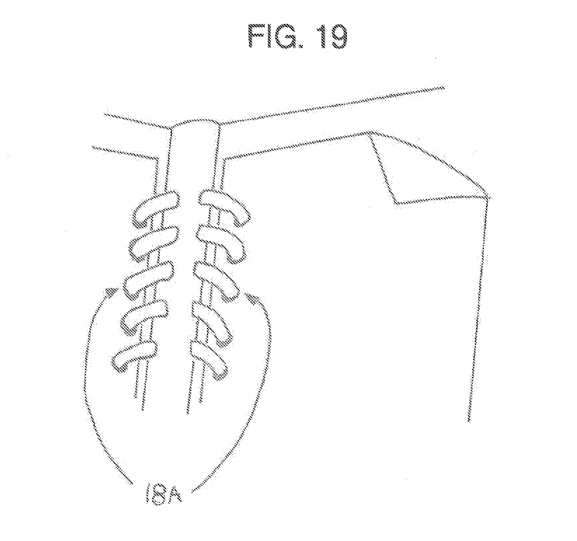

FIG. 19 is a preferred embodiment in which the binding may be replaced by a loose leaf binding arrangement 18A, so that the order of pages may be changed. The loose leaf binding arrangement 18A also allows the user to show certain pages and not others in case only certain pages resemble the child's school activities or other experiences. It also allows the user to easily interleave pages in any combination among the set of three books. The result is the assembly and formation of a separate and distinct activity book containing indicia in the form of text and/or photos and illustrations from any combination of the following sources: the teacher, the child, the parent, and the author.

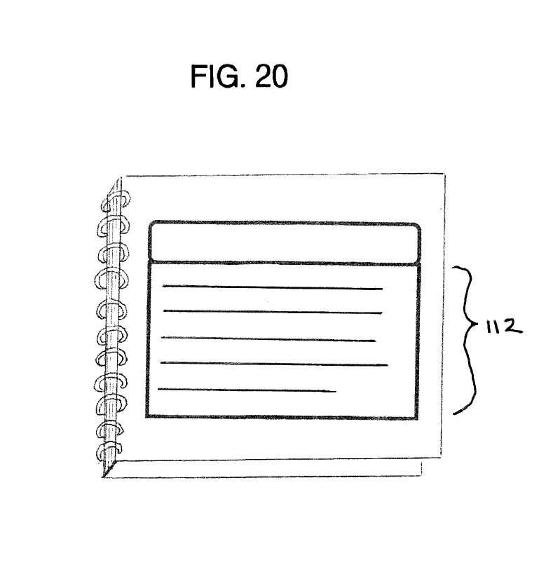

FIG. 20 is an example of “Let's Talk!” Conversation Starters about School according to the current iteration, designed to give parents and caregivers guidance on discussing school experiences with young children (age 2-6 yrs.). Specific examples of questions 112 are provided for a parent or caregiver to ask a child, along with spaces 112 under the questions to receive indicia in the form of text from the child.

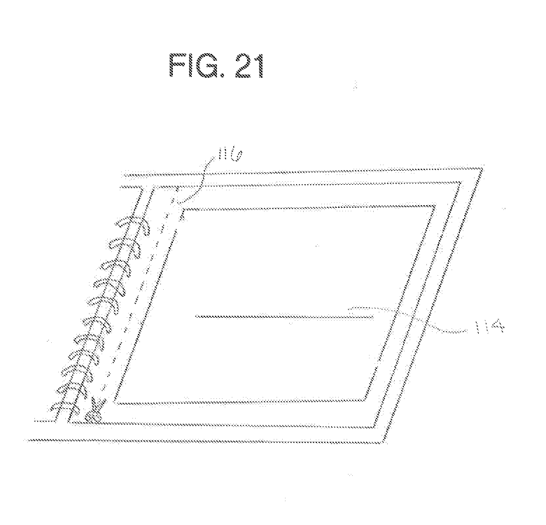

FIG. 21 is an example of a certificate of completion existing within the last pages of the “student book template,” which the child can personalize by writing his/her name in the space 114 provided, and signifying that the child user is ready to start school upon completion of the “student book template” activities. Additionally, the certificate of completion is structured to be removed by cutting or tearing along the dotted line 116 so it can be displayed on a wall, for example.

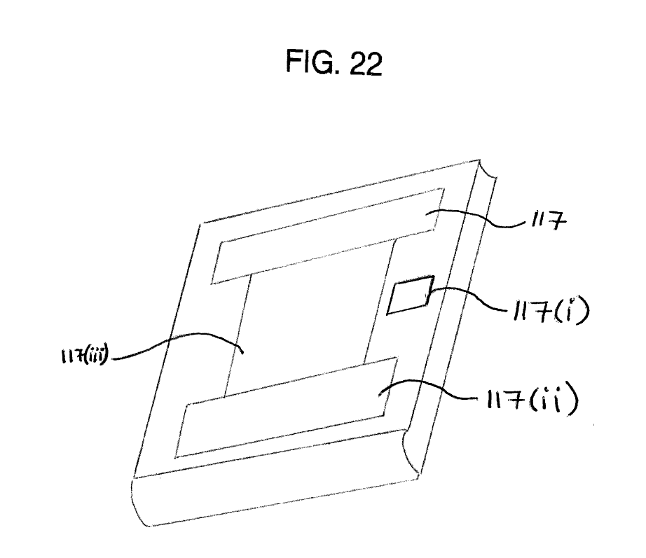

FIG. 22 is an example of the front cover of the “teacher book template” designed to identify the “teacher book template” as such and not intended to be populated with indicia in the form of text, photos and/or illustrations, provided by the “teacher”. In the current iteration of the invention, text 117 identifies the teacher book template using the following indicia in the form of text, “Teacher Book Template (English-Spanish): School is New to Me.” Further, in the current iteration of the invention, text 117 (ii) directs the teacher on how to use the teacher book template with the following instruction: “Use this to Customize the book, School is Nw to Me: A Beginner's Guide to Starting School. Reflect Your Classroom Activities and Achievements.” Indicia in the form of text 117(i) informs the teacher that the “teacher book template” can be customized electronically using word processing software such as Microsoft Word™, as well as in paper form: “Also available as an electronic document for you to Customize!” Photos and/or illustrations 117(iii) of the environment, setting or situation”, e.g., school, appear on the cover as well.

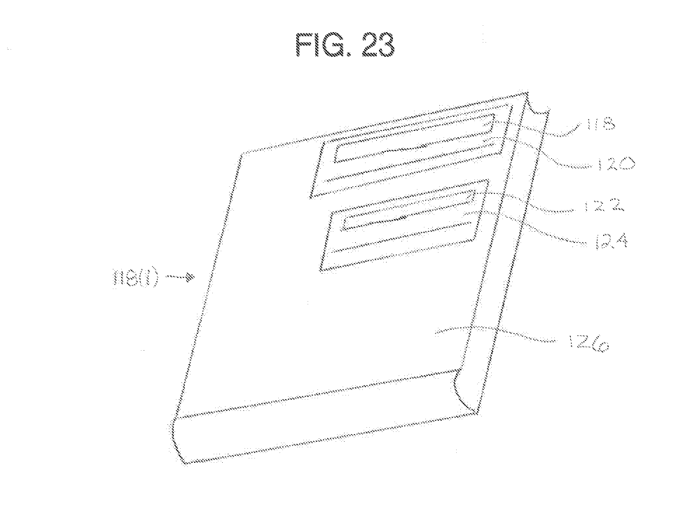

FIG. 23 is a sample of the front cover 118 (i) of the “teacher book template” designed to receive indicia in the form of text, photos and/or illustrations by the “teacher” in which the “teacher” has not yet provided such indicia. Text 118 is a portion of a book's title provided by the author, such as “Welcome to . . . ;” and the space 120 is designated for the teacher to provide the name of the school,e.g., “ABC Elementary School,” so that the entire title reads, “Welcome to ABC Elementary School,” for example. Text 122, e.g., “compliments of” or “provided by” indicates that the teacher is to provide his/her name in the space 124. Photos and/or illustrations 126 related to the environment, setting or situation, e.g., school, are provided.

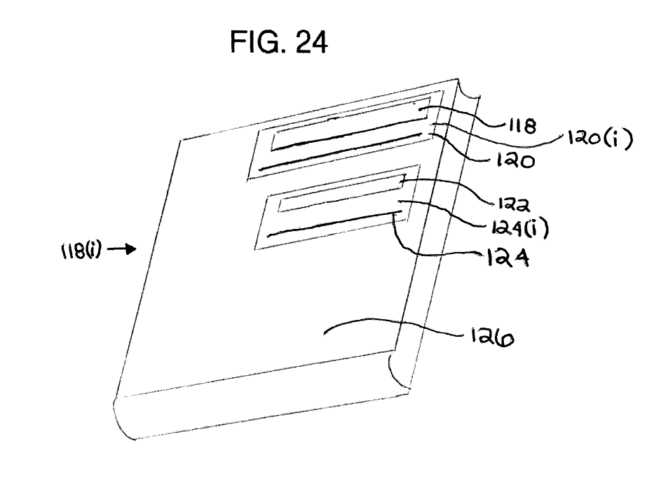

FIG. 24 is a sample of the front cover 118(i) of the “teacher book template” designed to receive indicia in the form of text, photos and/or illustrations by the “teacher,” in which the “teacher” has provided such indicia. Text 118 is a portion of a book's title provided by the author, such as “Welcome to . . . ;” and in the space 120 designated for the teacher to provide the name of the school, the teacher has provided such indicia 120(i) in the form of text, “ABC Elementary School,” so that the entire title reads, e.g., “Welcome to ABC Elementary School.” Text 122, e.g., “compliments of” or “provided by” indicates that the teacher is to provide his/her name in the space 124. The teacher has provided a name 124(i), Ms. Kelley, in space 124. Photos and/or illustrations 126 related to the environment, setting or situation, e.g., school, are provided.

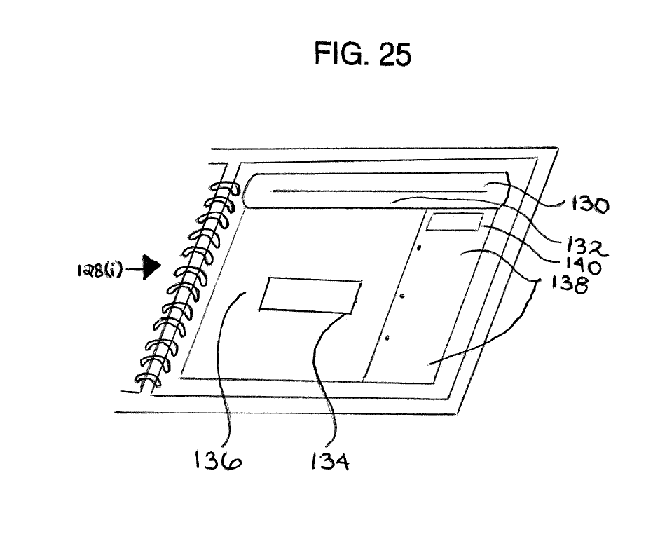

FIG. 25 is an example of a multiplicity of activity pages 128(i) within the “teacher book template” designed to receive indicia from the teacher in the form of text, photos and/or illustrations. In FIG. 25 the teacher has not yet provided such indicia. Text instructions 132 instruct the teacher to describe an activity, situation or environment e.g. “the classroom,” in text in the designated space 130. Text instructions 134 instruct the teacher to include a photo or illustration in space 136 of the activity, environment or situation referred to by text in space 130. There also is designated space 138 for the teacher to provide indicia in the form of text to instruct and advise parents on how to familiarize their child with the activity, environment or situation described with indicia in the form of text in space 130, and illustrated in space 136. In another aspect of the invention, text 140 serves as a title for the indicia in the form of text 138 provided by the teacher. In this iteration of the invention, text 140 reads, “Parents' Tips.”

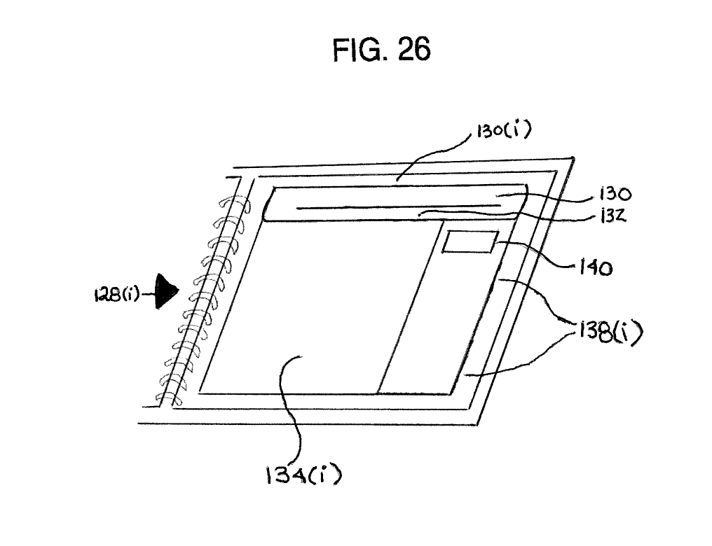

FIG. 26 is an example of a multiplicity of activity pages 128(i) within the “teacher book template” designed to receive indicia from the teacher in the form of text, photos and/or illustrations. In FIG. 26 the teacher has provided such indicia. Text instructions 132 instruct the teacher to describe an activity, environment or situation with indicia in the form of text in the designated space 130. Accordingly, the teacher has included the following indicia in the form of text 130(i): “The classroom.” The teacher also has provided a photo or illustration of the activity, environment or situation referred to by indicia in the form of text 130(i). The teacher also has provided indicia in the form of text 138(i) to instruct and advise parents on how to familiarize their child with the activity, environment or situation described with indicia in the form of text 130(i), and illustrated by photo or illustration 134(i). Additionally, text 140 serves as a title for the indicia in the form of text 138(i) . In this iteration of the invention, text 140 reads, “Parents' Tips.”

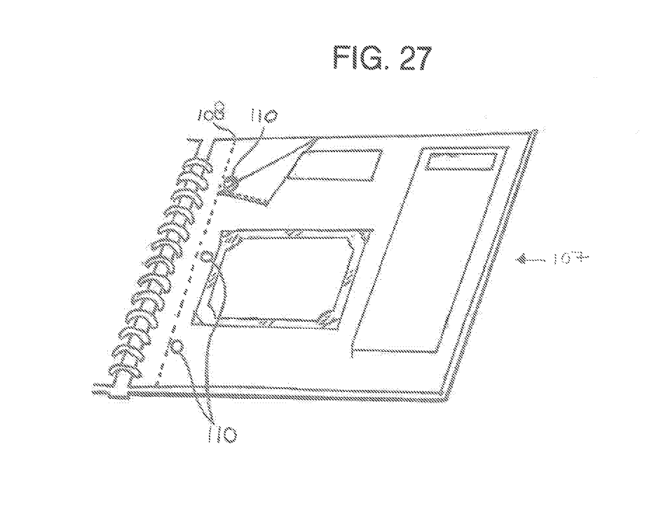

FIG. 27 is a preferred embodiment of the “teacher book template” in which each “template page” is perforated or dotted along the left side of the page so that each page may be ripped out or cut out by the teacher after he/she has populated the pages with indicia in the form of text, photos and/or illustrations, and placed the pages in any order the teacher chooses, and/or interleaved them among the pages of the “author's book” and/or interleaved them among the pages of the “student template pages” to create a separate and distinct activity book that reflects, e.g., the “teacher's” goals for the child or group of children, such as a class or other kind of activity-based group. In another aspect of this embodiment, each activity page of the “teacher book template” also has holes 110 along the left side of the page to accommodate placement in a ringed binder, so that each page may be removed by the user and placed in any order the user wishes within a ringed binder and/or interleaved within a ringed binder among the pages of the “author's book” and/or “student book template,” both of which will also have holes to accommodate placement in a ringed binder. The result is the assembly and formation of a separate and distinct activity book containing indicia in the form of text and/or photos and illustrations from any combination of the following four sources:

the teacher, the child, the parent, and the author.

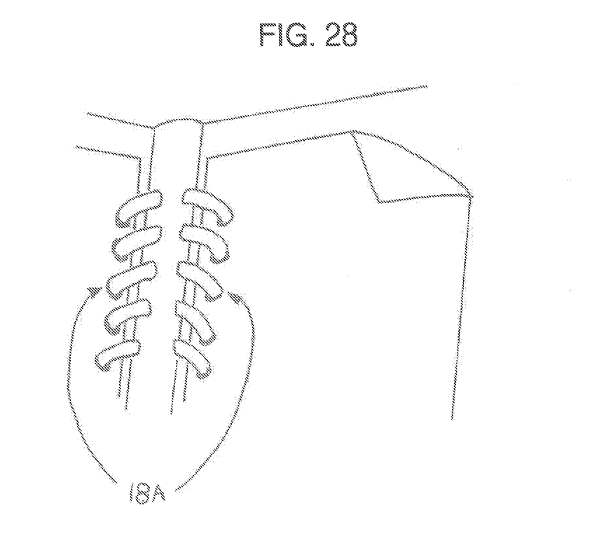

FIG. 28 is an example of the “teacher book template” being bound by a loose leaf notebook binder so that the teacher may change the order of the pages, remove and/or interleave pages from the “teacher book template” with pages from the “authors book” and/or with pages from the “student book template” to construct a separate and distinct activity book containing indicia in the form of text and/or photos and illustrations from any combination of the following four sources: teacher, child, parent, and author.

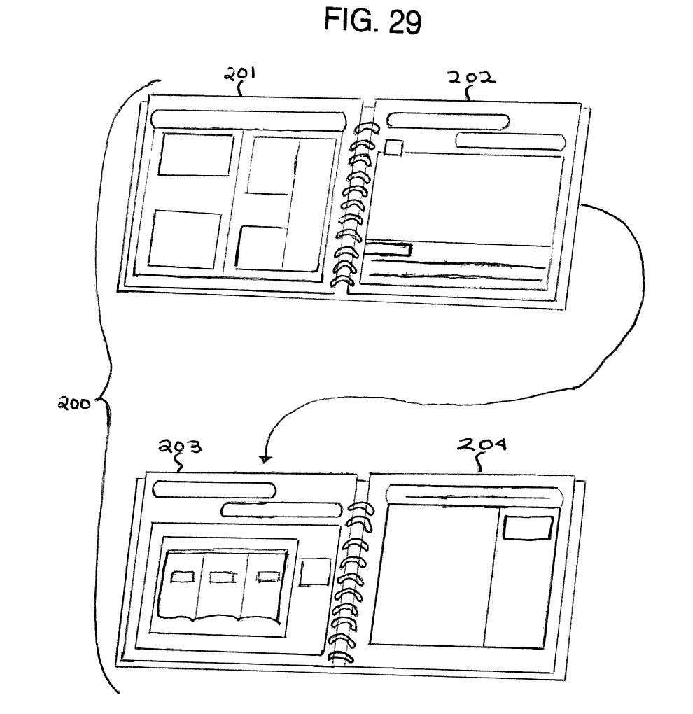

FIG. 29 is an example of the interior pages of an activity book comprised of some pages 202 and 203 from the “student book template,” and a page 204 from the “teacher book template,” interleaved with a page 201 from the “author's book.” FIG. 29 illustrates the result of the actions of user(s), such as a child, parent, caregiver and/or teacher which create the structure of the distinct and customized book 200. First the user(s) must deconstruct the arrangement of the three separate books containing pages 201, 202, 203, and 204 respectively by separating these pages from their respective books. Then the user must construct a new, distinct and customized book using these pages 201,202,203,204 in any configuration the user chooses.

This is an example of one configuration. Other configurations of interchangeability are available as options using the disclosed configuration of the books. This structural method and mechanism enables the child, parent, and teacher to flexibility to assemble a separate and distinct activity book that supports the transition of children to unfamiliar situations or environments such as but not limited to starting school.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1-32. (canceled)

33. A book comprising:
at least two pages wherein at least one of the at least two pages comprises:
an activity label field wherein the activity label field determines the subject matter content of the page on which is appears,
a picture field wherein the picture field illustrates an activity and/or situation relating to the activity label,
a text field wherein the text field describes the activity and/or situation illustrated in the picture field,
a parent tips field, wherein the parent tips field includes information which guides a parent regarding how to discuss the activity and/or situation with a child and/or how to help the child adjust to the activity and/or situation.

34. The book of claim 33 wherein, the activity label field is positioned at the top of the page, the picture field is positioned below the activity field, and the parent tips field positioned either below the picture field or along a margin of the page.

35. The book of claim 33 wherein, the picture field illustrates a child engaged in the activity and/or situation relating to the activity label.

36. The book of claim 35 wherein, the text field describes the experience of the child shown in the picture field.

37. The book of claim 33 wherein, the book comprises at least one page comprising an activities field, wherein the activities field includes text directing a child to complete a stated task wherein the stated task is related to text, a photograph, and/or illustration included on the page.

38. The book of claim 33 wherein, the specific illustration in the picture field is provided by a user or third party.

39. The book of claim 33 wherein, the specific text in the text field is provided by a user or third party.

40. The book of claim 33 wherein, the specific activity label in the activity label field is provided by a user or third party.

41. The book of claim 33 wherein, at least one field includes a designated area for users to insert text, a photo, and/or an illustration.

42. The book of claim 41 wherein, all fields include a designated area for users to insert text, a photo, and/or an illustration.

43. The book of claim 33 wherein, all pages of the book comprise
an activity label field wherein the activity label field determines the subject matter content of the page on which is appears,
a picture field wherein the picture field illustrates an activity and/or situation relating to the activity label,
a text field wherein the text field describes the activity and/or situation illustrated in the picture field,
a parent tips field, wherein the parent tips field includes information which guides a parent regarding how to discuss the activity and/or situation with a child and/or how to help the child adjust to the activity and/or situation.

44. A method for acclimating a subject to unfamiliar activities and/or environments comprising:
providing at least two pages to a subject wherein at least one of the at least two pages comprises:
an activity label field wherein the activity label field determines the subject matter content of the page on which is appears,
a picture field wherein the picture field illustrates an activity and/or situation relating to the activity label,
a text field wherein the text field describes the activity and/or situation illustrated in the picture field,
a parent tips field, wherein the parent tips field includes information which guides a parent regarding how to discuss the activity and/or situation with a child and/or how to help the child adjust to the activity and/or situation.

45. The method of claim 44 wherein, the unfamiliar activity and/or environment is selected from the group consisting of attending school, preschool, child care, pre-kindergarten, and kindergarten.

46. The method of claim 44 wherein, the picture field illustrates a child engaged in the activity and/or situation relating to the activity label.

47. The method of claim 46 wherein, the text field describes the experience of the child shown in the picture field.

48. The method of claim 44 wherein, the at least two pages comprise at least one page comprising an activities field, wherein the activities field includes text directing a child to complete a stated task wherein stated task is related to text, a photograph, and/or illustration included on the page.

49. The method of claim 44 wherein, the specific illustration in the picture field is provided by a user or third party.

50. The method of claim 44 wherein, the specific text in the text field is provided by a user or third party.

51. The method of claim 44 wherein, the specific activity label in the activity label field is provided by a user or third party.

52. The method of claim 44 wherein, at least one field includes a designated area for users to insert text.

53. The method of claim 44 wherein, specific text of the parent tips field is provided by a user or third party.

54. The book of claim 33 wherein, specific text of the parent tips field is provided by a user or third party.

55. The book of claim 33 wherein, a user or third party may alter the order of the pages to reflect a specific sequence of activities without damaging the book.

56. The method of claim 44 wherein, a user or third party may alter the order of the pages to reflect a specific sequence of activities without damaging the pages.
